(19) United States
(12) Patent Application Publication
(10) Pub. No.: US 2001/0030274 A1
(43) Pub. Date: Oct. 18, 2001

(54) Shock and vibration mount

(76) Inventors: Kelli Corona-Bittick, Fairfield, CT (US); Jim Dorr, Ftmyers, FL (US); Colin Ratcliffe, Millersville, MD (US)

Correspondence Address: Mark Manley, Center for Technology and, Small Business Development, Grinstead 014, Warrensburg, MO, 64093, US

(21) Appl. No.: 09/734,408

(22) Filed: Dec. 11, 2000

Related U.S. Application Data
(60) Provisional application No. 60/170,393, filed on Dec. 13, 1999.

(51) Int. Cl. F16M 13/00

(52) U.S. Cl. 248/634; 248/633; 248/632

(57) ABSTRACT

A machine mount is disclosed. The mount is ideally suited for naval applications but is generally applicable to any type of equipment. The shock and vibration absorbing part of the mount is made of elements of molded urethane or similar material that change shape as static loading increases. The mount has elements shaped to give a smooth but non-linear, increasing response in static loading. As the static load is applied the extra deformation increases the mount stiffness in two ways, there is an increase in load to mount surface contact area and the elements of the mount change from flex loading to shear and compression as the shape of the elements change under load. The natural frequency of the mount in loading is low and relatively constant over a wider range of static loads then prior art mounts. The advantages include a significant increase in shock and vibration performance compared to current mount designs, allowing a significant reduction in the number of different mounts required to cover the large range of system configurations and attendant cost reduction.

### BACKGROUND OF THE INVENTION

In addition to the static loading from its weight, equipment generates vibrations as it operates. In certain operational environments, equipment also has to have protection from shock. It is important therefor to isolate this equipment from the surfaces upon which it is mounted. Typically, natural rubber pads or mounts are placed under the equipment to dampen and absorb some of the vibration. One problem with natural rubber mounts is that they typically have only a linear response to a static load, this allows for too much amplitude or travel as a result of vibration. Rubber mounts also have a high natural frequency, which means they do a poor job of dampening out vibrations. Rubber mounts also tend to have too much compression during static loading, which can result in a variety of problems including equipment misalignment. Another problem with rubber mounts is that the natural frequency of the mount changes according to the static load applied. To maintain a desirable low natural frequency it is necessary to have a large number of different rubber mounts available to cover a range of static loads. It would be desirable to have a mount with a natural frequency that was constant over a wide range of static loads.

Polyurethane, or other stiffer materials do a better job of maintaining a static load but typically this type of material will just transmit vibration and shock loads right through the mount.

As a result of these limitations, equipment is often mounted using several different mounts of different materials to cover a range of different types of loading from shock loading to vibrations. The result is an increased cost to get the required performance.

In addition to material it is common to use shape and size to vary the response of a mount to different types of loading situations.

There is not currently a mount for naval applications having good combined vibration and shock performance. Perhaps the closest is the wire-wound Aeroflex mount. However, this is not a good mount. It is difficult to install; its vibration attenuation properties, particularly at high frequencies, are very poor; and under shock the mount can ‘bottom out’ and transmit high shock loads to the supported equipment. Even under tension, the Aeroflex mount quickly ‘locks up’ and transmits high loads.

### SUMMARY OF THE INVENTION

The concept is to have an equipment mount component whose stiffness changes because its shape factor changes. For small deflections, the shapes that seemed most appropriate (i.e. non-linear) were cones and circular sections—the contact is initially only on a small contact area, which easily deflects under load. As the load increases, the deformation means more surface area comes in contact, leading to increased stiffness. During this procedure, the material predominantly operates in its linear region. While spherical components are not feasible for the shock mount, literature on bearings documents the contact of spheres (ball bearings) on various surfaces. Contacting spheres demonstrate a nonlinear stiffening behavior.

The advantages of the new design include a significant increase in shock and vibration performance over a wider range of static loading compared to current mount designs, allowing a significant reduction in the number of different mounts required to cover the large range of shock and vibration isolation requirements and attendant cost reduction. The new mounts are lighter weight and less expensive than current mounts.

We have developed a low-cost, high-performance generic elastomeric machinery mount system. The mount has varying static and dynamic vibration properties such that it provides vibration and shock isolation over a wider operating load range than is possible with current in-service mounts. The new mounts is capable of meeting performance specifications for several mounts/load ranges as given in MIL-M-17185 (General Mount Spec.), MIL-M-17191 (P-Type Mounts), MIL-M-17508 (E-Type Mounts), MIL-M-19379 (M-Type Mounts), MIL-M-19863 (5B5000 Mounts), and MIL-M21649 (5M1000 Mounts).

FIG. 1 shows the cross section of the current mount (1). The spool components (16,18,20) are made from a composite fiberglass/epoxy material unlike the prior art device where the spool is steel. The flange (10) is also of composite fiberglass/urethane material. The composite spool (18) is bonded to the top cap (16) and lower cap (20). But the spool (18) passes through the flange (10). There can be a slight gap (19) between the flange (10) and the spool (18). The flange (10) has bolt holes (12) through which bolts (not shown) pass to attach the flange to a fixed surface such as the floor or wall. A downward load applied to the top cap (16) compresses the upper urethane element (21) and stretches the lower element (22) which are both bonded to the flange (10). As the load is applied to the top cap (16) the element (21) starts to compress. The upper element (21) and lower element (22) have a “Y” shaped cross section. As the load increases the arms of the “Y” flex. The smaller arm (40) and larger arm (42) are sized according to a design static loading. These “arms” are cross sectional views, the sections 40 and 42 are actually cone shaped. The lip (46) prevents the elements (21, 22) from slipping off the caps (16, 18). The elements (21, 22) are bonded to the caps (16, 18), the flange (10) and the spool (18) at the points where they contact. As the static load grows larger the stress of the pad changes from flex of the arms to compression and shear stress on the arms (40, 42). This gives the pad its non-linear response to loading. The non-linear response to loading yields a nearly constant, low natural frequency for the pad. This design has only one material in the active pads (polyurethane). For example, the element could be Adiprene L-100 and Caytur 21 polyurethane combined at a rate of 4.88 pbw to 1 pbw. It relies solely on a changing shape factor to cushion loading. As the static load is applied, the extra deformation increases the stiffness of the arms (cones) in two ways: a) there is an increased contact area between the arm and the cap, and b) the parts of the element predominantly in flexure slowly change to be more in compression and shear. This design thus has a smooth progression of stiffness with static load.

As can be seen in FIG. 2, the elements (21, 22) have an overall ring shape. The smaller arm (40) is a three dimensional truncated cone. The larger arm (42) is an inverted cone which makes the entire mount (except for flange 10) axisymmetric about the spool. The cones have a “Y” shape if a cross section is taken.

We have demonstrated that an elastomeric composite mount can be produced that will replace at least 4 current Navy mounts with a lower natural frequency over the full load range. This mount is low cost, durable, corrosion resistant, light-weight, and has improved vibration isolation and is shock resistant.

Testing of the mount proved that the mount concept could support a wider range of static loads than existing mounts. Over the static load range of 100- 750 pounds, the mount which has been fabricated and tested, has a natural frequency of approximately 5 Hz which is between 1.5 and 6 Hz lower than that achieved using three mounts from the EES family. The mounts can potentially have a range of 20-3500 pounds.

### BRIEF DESCRIPTION OF THE DRAWINGS

FIG. 1 Shows a cross sectional view of the mount

FIG. 2 Shows an isometric view of the mount

FIG. 3 Shows a view of a section of the current device under static loading

FIG. 4 Shows a graph of the performance of the current device and of the prior art device.

FIG. 5 Shows the prior art mount

FIG. 6 Shows a second embodiment of the mount

FIG. 7 Shows the performance curve of the second embodiment.

FIG. 8 is a graphical representation showing the performance of the mount of FIG. 6 under a 750 pound load.

### DESCRIPTION

A big advantage of the current design is that it is substantially lighter weight than the prior art mount. Weight reduction is achieved through use of composite materials in the spool (18), flange (10), and caps (16, 20). Also the polyurethane elements (21, 22) are lighter than the prior-art solid rubber pads.

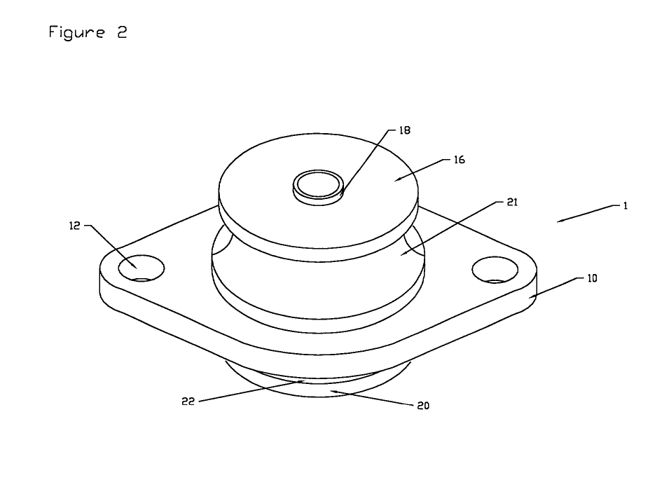

FIG. 2 shows a view of the outside of the mount (1). The flange (10) has bolts holes (12) that allow the flange to be attached to a solid surface such as the floor. Top cap (16) provides a surface to place a load (equipment) on. The spool (18) has a hole that passes through it which will allow for attaching the load to the mount. The spool (18) passes clear through the center of the mount and is bonded to lower cap (20).

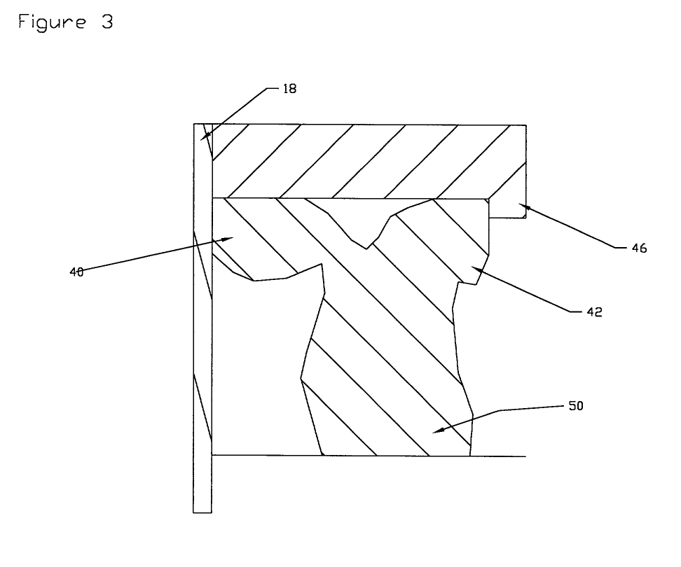

FIG. 3 shows a close-up view of a part of an element (21, 22) in compression. As can be seen the surface contact between the arms (40, 42) with the upper cap (16) has increased dramatically. The section (46) will prevent the outer arm from slipping off the cap (16) while the spool (18) retains the inner arm. This will result in a shape change response to loading. Also in this position the flex is out of the arms (40, 42) and most of the stress associated with loading is now absorbed by the trunk section (50).

In operation, the flange is bolted to a fixed surface. The equipment can sit on top of the spool, and a second bolt passes through the equipment and spool to attach the equipment to the mount. Alternatively, the flange can be attached to a ceiling or wall. In this case a bolt will pass through the shaft and support a weight that will hang from the mount. This might be true for pipes or electrical equipment.

Once installed the mount will be subject to vibrations coming from all directions. Some vibrations may come from the equipment whereas others may come from the surface the equipment is mounted on.

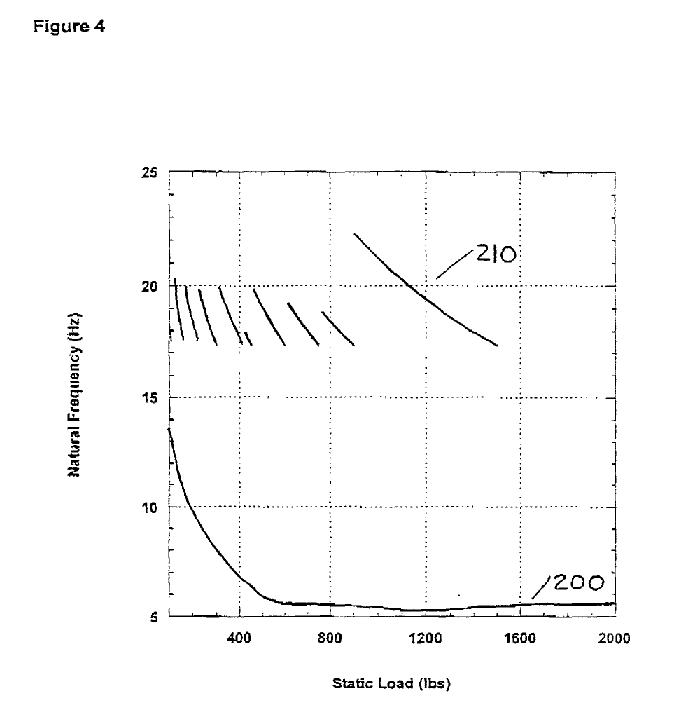

FIG. 4 graphically shows the performance of the prior art mounts and the current mount. The curve (200) shows the effect of static loading on the natural frequency of the mount. As can be seen the natural frequency of the current mount is low (about 6 Hz) and relatively constant for static loading varying from 100 to 2000 pounds. The line (210) shows the approximate performance of a set of prior art mounts. Each tooth of the graph represents another mount in the set. Therefore it takes many prior art mounts to provide the same range of loading that a single mount of the current design can cover.

Referring to FIG. 4 in designing a mount for a given loading, say 1500 pounds, clearly the mount of the current design would handle the loading and be very effective at dampening vibrations because of the low natural frequency (6 Hz) that it is operating at with that loading. This is important for the designer. If the static load is not exactly known (which is usually the case) it doesn't matter for the current mount because it will have a natural frequency of about (6 Hz) for the range of 1200 pounds to 5000 pounds. This gives the designer a fantastic margin for error and will substantially reduce the time it takes to select a mount for a given application. With the prior art if the load is 1200 pounds or 1800 pounds instead of 1500 pounds it would dictate the use of a different mount, therefore the loading on a mount would need to be very well known and could not vary substantially for optimum mount performance. Also the FIG. 4 shows that none of the prior art mounts achieve a natural frequency below 15 HZ, except over a very narrow load range, which is another factor in favor of the mount of the current design.

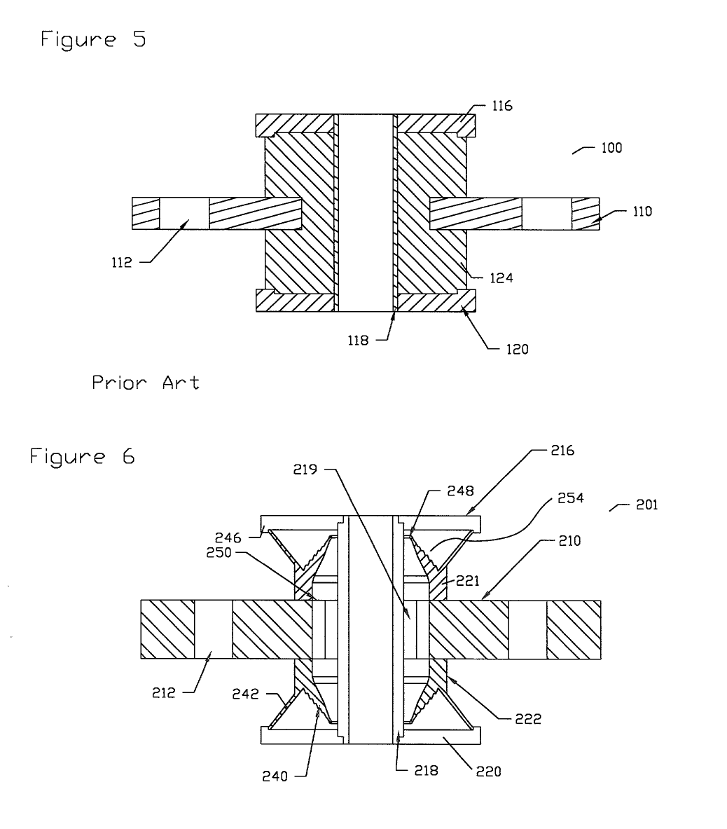

FIG. 5 shows the prior art equipment mount (100). The prior art mount has a steel flange (110) with bolt holes (112) through which bolts will pass to attach the flange to a fixed surface such as a floor or ceiling. In the prior art equipment will sit on the top plate (116) of the spool (118). Clearance in the floor makes space for the lower plate (120) of the spool (118). Vibrations from the equipment are absorbed by natural rubber mounts (122) and (124). Static loading (the weight of equipment) applied to the top plate (116) will compress the upper rubber mount (122) and stretch the lower mount (124) which is bonded to the flange (110). In this prior art mount the higher the loading on the top plate (116) the lower the natural frequency response of the mount to vibrations. A low natural frequency is desirable so the prior art mount reaches its peak performance at its limit of static loading, however prior art mounts are normally used up to about 70% of maximum rated load which further degrades their dynamic performance.

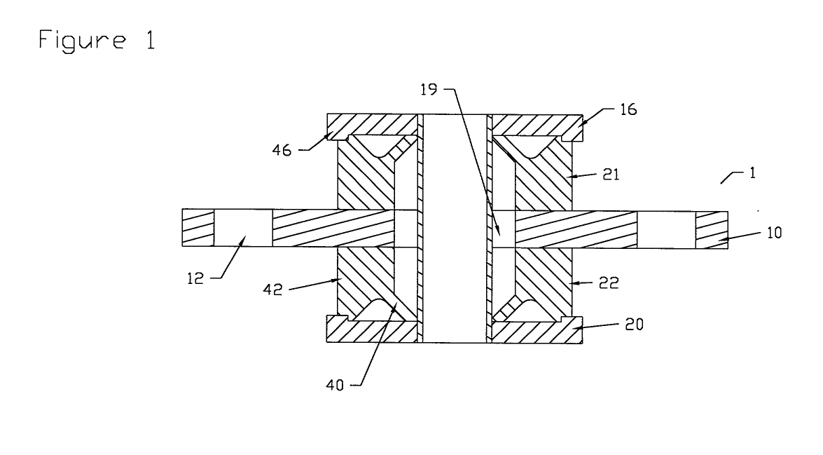

FIG. 6 shows a second possible embodiment of the concept with many elements like those of the first embodiment. The mount (201) has a flange (210) with mounting holes (212). The composite spool (218) is bonded to an upper cap (216) and a lower cap (220). The spool (218) passes through the flange (210) with a gap (219). Bolts (not shown) pass through the holes (212) to attach the flange (212) to a fixed surface. A downward force applied to the top cap (216) compresses the upper urethane element (221) and stretches the lower urethane element (222), both elements (221 and 222) being bonded to the flange (210). The top element (221) and bottom element (222) have a “Y” shaped cross-section and are the same element except that one is upside-down. In the embodiment of FIG. 6 the smaller arm (142) starts out supporting the load with the heavier arm (140) spaced slightly away. As a load is applied to the top cap (216) of the mount the larger (stiffer) cone (240) in the top element (221) becomes engaged and begins to compress. This second engagement results in a step increase in the stiffness of the mount. Again the embodiment of FIG. 6 takes advantage of the fact that the shape of the cones (whose cross sections are 240 and 242) change as the static load on the mount increases. This shape change results in an increase in the stiffness of the mount. Like the mount of FIG. 1, the mount of FIG. 6 is primarily designed to support and dampen axial loads and shocks. Some lateral loading can be absorbed by the cones (240, 242) but larger lateral loads will result in the bumper (250) coming up against the spool (218).

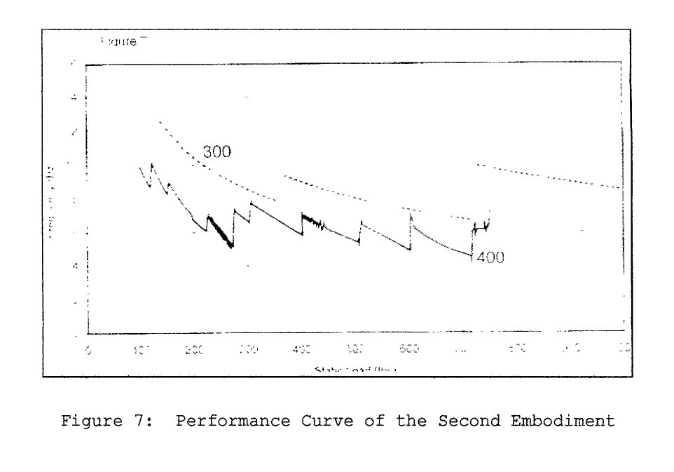

Steps (254) on the inside surface of the stiffer cone provide a stepwise increase of the stiffness of the mount. These steps (254) actually are a cross sectional representation of rings on the upper surface of the stiff cone (240). As can be seen in FIG. 7, the performance under loading of this mount can be represented by a series of steps in performance curve (400). This performance curve is desirable, as the natural frequency of the mount remains nearly constant over a range of loads from 100 to 700 pounds. At the start of loading the stiffer cone acts as a conical cantilever. As the static load is increased, the top cap (216) progressively contacts more of the surface of the stiffer cone. This increased contact reduces the length of the lever arm of the cantilever and increases the amount of the cone in pure compression thus significantly increasing the stiffness of the mount. As the cap (216) moves down in loading it contacts each of the steps (254) in sequence from top to bottom, as the cone (240) deflects. These steps give rise to some of the stair stepping of the load curve shown in FIG. 7 that helps to maintain a relatively constant natural frequency from a static loading of about 100 pounds to a static loading of about 700 pounds. The curves, (300) represent the performance of the prior art mount where two different mounts are required and still they can not maintain as low and steady a natural frequency as the single mount disclosed.

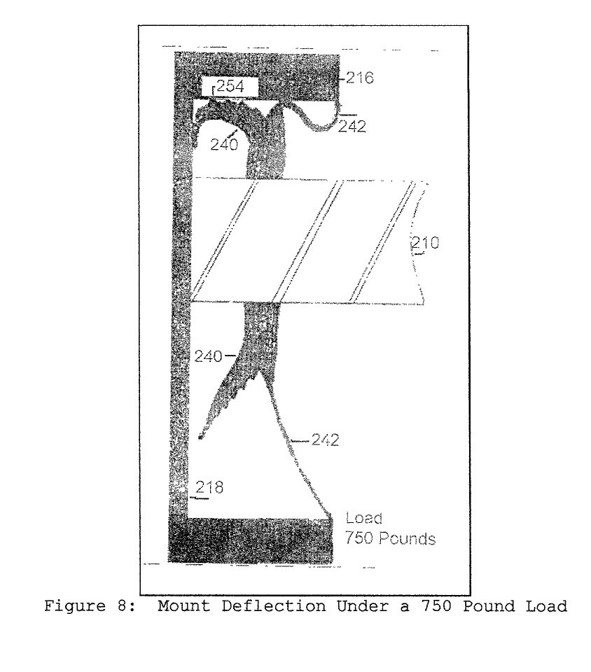

FIG. 8 is a graphical representation of the upper and lower cones under a mount loading of 750 pounds. As can be seen in the FIG. 8 the upper mount has been compressed and the lower mount is being stretched. The spool 218 keeps the upper stiff cone (240) in place as its shape changes. Note the contact and compression of the individual steps (254) against the upper cap (216). The lower cone (240) is inactive during this compression, while the more flexible cone (242) stretches because it is bonded to the lower cap. An advantage of this mount, like the one of FIG. 1 is that it can be installed with either cap as the upper cap, so it can not be installed in an incorrect orientation.

The cone shapes shown for the embodiments of FIGS. 1 and 6 are for the purposes of illustrating the concepts. The cone works well but any shape that allows the mount to exhibit an increasing area of contact as the static load increases would work. The exact size and shape of the cones being determined by the desired design characteristics required by the load being supported.

Having thus described the current mount, what is claimed is:

1. A static load supporting, vibration dampening equipment mount comprising:
a top plate with a top surface and a bottom surface;
a urethane pad having a urethane trunk section and having at least one thinner urethane cone extending from said trunk to said plate;
a flange attached to a solid surface, said trunk sitting on said flange such that when said static load is applied to said top plate said cone supports said load primarily by flexing;
and as said load is increased said arm supports the load by a combination of flexing, compression and shear.

2. The mount of claim 1 wherein said arm has an upper surface partially in contact with said bottom surface of said top plate;
said cone having a first position when said loading is low where the area of contact between the arm and the bottom surface is small;
and said cone having a second position where the area of contact between the cone and the bottom surface is larger.

3. A static load supporting, vibration dampening equipment mount comprising:
a top plate with a top surface and a bottom surface;
a urethane pad having a urethane trunk section and having a first integrally formed urethane cone extending from said trunk to said plate;
a flange attached to a solid surface, said trunk sitting on said flange such that when said static load is applied to said top plate said cone supports said load primarily by flexing;
and as said load is increased said arm supports the load by a combination of flexing, compression and shear.

4. The static load supporting mount of claim 3 including;
A second integrally formed urethane cone, coaxial with said first urethane cone;
Wherein said load is fully supported upon said first urethane cone for small loads and wherein a larger load is supported upon both the first urethane cone and upon the second urethane cone:

5. A static load supporting, vibration dampening equipment mount comprising:
a top plate with a top surface and a bottom surface;
a urethane pad having a urethane trunk section and having at least one urethane cone extending from said trunk to said plate;
a flange attached to a solid surface, said trunk sitting on said flange such that when said static load is applied to said top plate said cone supports said load primarily by flexing;
and as said load is increased said cone supports the load by a combination of flexing, compression and shear; said cone having a top surface;
said top surface having a series of concentric annular steps;
such that as the load is applied to said top plate the bottom surface of the top plate contacts the annular steps sequentially providing a stepwise increase in mount stiffness.
